(19) United States
(12) Patent Application Publication
(10) Pub. No.: US 2018/0281385 A1
(43) Pub. Date: Oct. 4, 2018

(54) Multipurpose Inkjet Print Head and Method of Operating Such Inkjet Print Head

(71) Applicant: Océ Holding B.V., Venlo (NL)

(72) Inventor: Amol A. Khalate, Venlo (NL)

(21) Appl. No.: 15/920,912

(22) Filed: Mar. 14, 2018

(30) Foreign Application Priority Data
Mar. 28, 2017 (EP) 17163302.7

(51) Int. Cl. B41J 2/045

(52) U.S. Cl. CPC B41J 2/0455; B41J 2/04541; B41J 2/04571; B41J 2/0456; B41J 2/04581

(57) ABSTRACT

An inkjet print head includes a droplet ejection unit having a pressure chamber; a first actuator configured for changing a volume of the pressure chamber; a second actuator configured for changing the volume of the pressure chamber; and a nozzle orifice. The inkjet print head further includes a control circuitry operatively connected to the first actuator and the second actuator. The control circuitry includes a drive circuitry for supplying a drive signal to at least one of the first and the second actuator; a sensing circuitry for receiving a sense signal from the first actuator; and a switch circuitry for switching a connection of the first actuator between a connection to the drive circuitry and a connection to the sensing circuitry.

### CROSS-REFERENCE TO RELATED APPLICATION

This application claims priority to European Patent Application No. 17163302.7 filed Mar. 28, 2017, the disclosure of which is hereby incorporated in its entirety by reference.

### BACKGROUND OF THE INVENTION

### Field of the Invention

The present invention generally pertains to an inkjet print head for use with multiple kinds of ink, while providing reliability and/or productivity. Further, the present invention pertains to a method of operating such an inkjet print head.

### Description of Related Art

Inkjet print heads are well-known in the art. In particular, different kinds of actuation techniques are known. One well-known droplet ejection technique is the use of an actuator for changing a volume of a pressure chamber, in which pressure chamber a liquid is present. Changing the volume of the pressure chamber induces a pressure change in the liquid. The pressure change results in a pressure wave that ultimately may result in a droplet of the liquid being expelled from a nozzle orifice, which nozzle orifice is in fluid communication with the pressure chamber. It is known to use a piezo-electric actuator to expel droplets, but also to be used as a sensor to sense a residual pressure wave after droplet ejection in order to detect a state of a droplet ejection unit.

As used herein, a droplet ejection unit comprises a pressure chamber and a nozzle orifice, all in fluid communication, and further an actuator arranged for changing a volume of the pressure chamber upon actuation.

For use as both an actuator and a sensor, it is known to apply a switch such that the piezo-electric element may be connected to a drive circuitry for use as an actuator or may be connected to a sensing circuitry for use as a sensor. A disadvantage of this known print head is that during a drive period, in which an ejection drive signal is applied to the piezo-electric element, the piezo-electric element cannot be used as a sensor at the same time.

In order to obviate the above-mentioned disadvantage, it is known to add a pressure sensor in addition to the actuator such that a pressure in a liquid in the pressure chamber may be sensed and monitored, while the actuator is operated. Thus, more information on the acoustics in the pressure chamber during actuation may be obtained. On the other hand, the costs are increased significantly, which results in a commercially not-feasible inkjet print head design.

### SUMMARY OF THE INVENTION

It is an object of the present invention to provide an inkjet print head and corresponding method of operating such inkjet print head that is able to detect a pressure in a liquid in the pressure chamber during actuation, while being commercially feasible.

In a first aspect of the present invention, an inkjet print head is provided, wherein the inkjet print head is configured to eject a droplet of a liquid and comprises a droplet ejection unit and a control circuit. The droplet ejection unit comprises a pressure chamber; a first actuator configured for changing a volume of the pressure chamber; a second actuator configured for changing the volume of the pressure chamber; and a nozzle orifice. The control circuitry is operatively connected to the first actuator and the second actuator and the control circuitry comprises a drive circuitry for supplying a drive signal to at least one of the first and the second actuator; a sensing circuitry for receiving a sense signal at least from the first actuator; and a switch circuitry for switching a connection of at least the first actuator between a connection to the driving circuitry and a connection to the sensing circuitry.

In the inkjet print head according to the present invention, at least two actuators are provided per droplet ejection unit, i.e. per pressure chamber. At least one of those at least two actuators may be selectively connected to either a driving circuitry for changing a volume of the pressure chamber or a sensing circuitry for detecting a pressure in the liquid in the pressure chamber. Thus, for example, the droplet ejection unit may be operated by dual actuation and thereafter sensing a residual pressure wave or the droplet ejection unit may be operated by a single actuation and simultaneous sensing of a generated pressure.

The inkjet print head according to the present invention may be used for multiple purposes, increasing the applicability of the inkjet print head. As a consequence, larger quantities of the inkjet print head may be manufactured and other application-specific designs may be omitted. Thus, the costs for developing and manufacturing suitable inkjet print heads are reduced significantly, increasing commercial feasibility.

Moreover, with such a multi-purpose inkjet print head, a printing assembly incorporating such an inkjet print head becomes a versatile printing assembly suitable for multiple kinds of ink and multiple kinds of printing methods. For example, using a same ink, a high-reliability printing mode may be used, wherein it is determined for each and every droplet whether it has actually been ejected, or a high-speed printing mode may be used, wherein both actuators complement each other in driving in order to achieve a highest possible droplet ejection rate and droplet volume. A commercial value of a versatile inkjet print head is of course higher, which justifies a higher manufacturing cost and increases the commercial feasibility.

In a second aspect, as above mentioned, the present invention provides a method of operating the above described inkjet print head. The method comprises the steps of selecting a drive mode for driving at least one of the first and the second actuator for ejecting the droplet of the liquid through the nozzle orifice; and selecting a sensing mode for receiving the sense signal from the first actuator for detecting a pressure in the pressure chamber. The drive mode and the sensing mode are selected on the basis of at least one print property of a group of print properties. The group of print properties at least comprises a liquid viscosity, a liquid density, a droplet size, a printing productivity and a printing quality.

With a suitable selection of the drive mode and the sensing mode, the inkjet print head according to the present invention may be operated in accordance with different aspects such as liquid properties, including but not limited to liquid viscosity, liquid density and surface tension, enabling to use the inkjet print head with different liquids. Printing properties that may be taken into account for selecting the drive mode and the sensing mode include, but are not limited to a droplet size, a printing productivity and a printing quality. Depending on the application, a larger droplet size may be desirable, a high productivity may be desirable or a high printing quality, including a high droplet ejection reliability, may be desirable.

For example, if the printed result is used for manufacturing a functional electrical circuit, each and every droplet is required to prevent an excessive electrical resistance (or even a broken contact) or an electrical short-circuit. In such an application, it is paramount that every droplet is actually ejected and a printing speed is only of secondary importance. On the other hand, for printing images for large distance viewing, missing a few droplets is not so important as the image defects will not be seen at the intended viewing distance, while the size of the image may be presumed to be relatively large. Thus, in view of commercial relevance, time consumption for printing the image may be kept low to reduce costs and hence a high print productivity may be preferred over print quality. A person skilled in the art readily understands which application may require certain properties and is presumed to be able to contemplate and select such application related properties.

In an embodiment, the above-mentioned method steps are preceded by the steps of applying a predetermined analysis drive signal to at least one of the first actuator and the second actuator; receiving the sense signal from the first actuator; and analyzing the sense signal for determining at least one acoustic property of a group of properties of the pressure chamber and a liquid present in the pressure chamber. The group of acoustic properties at least comprises the liquid viscosity, the liquid density, an actuator efficiency and a presence of acoustic disturbances. As known in the art, when used as a sensor, the actuator detects a pressure, in particular a time-variant pressure, in a liquid in the pressure chamber. Based on the received signal, it is possible to identify characteristics of the acoustics in the pressure chamber. These acoustics determine the droplet ejection process. So, with identifying one or more acoustic properties through a sensing operation, it is possible to identify an optimal drive mode for ejecting droplets. For example, a liquid viscosity and a liquid density may have an effect on a droplet ejection frequency. So, by determining at least one of the liquid viscosity and the liquid density, a droplet ejection frequency may be selected as a property of the drive mode. Alternatively or additionally, acoustic disturbances, like a gas bubble or a dirt particle in the droplet ejection unit, may be detected, requiring a maintenance operation like a specific actuation sequence or just a higher actuation voltage. A person skilled in the art is presumed to understand and to contemplate any suitable drive properties in response to detected acoustic properties.

Moreover, when selecting a suitable drive mode, the skilled person will also be able to contemplate a suitable sensing mode. For example, a certain liquid viscosity, liquid density or surface tension may give rise to potential ejection disturbances like entrapping air forming a gas bubble. In such circumstances, the skilled person may select a sensing mode in which the acoustics are sensed and determined at a high frequency to detect the presence of a gas bubble in an early stage. In another example, the skilled person may employ the sensing mode to detect a subsequent ejection timing based on a residual pressure wave generated by a previous droplet ejection. Thus, the sensing mode may be employed to have a high droplet ejection frequency with a minimum of ejection failures.

In an embodiment, the inkjet print head is operated in a high-productivity mode, wherein the high-productivity mode comprises driving both the first and the second actuator in a predetermined interrelation for ejecting the droplet of the liquid. Taking into account relevant acoustic properties, both actuators may be driven in an interrelated manner such that a maximum droplet ejection frequency is achieved. Note that, between drive actuations, at least one of the actuators may be used as a sensor.

In an embodiment, the inkjet print head is operated in a high-reliability mode, wherein the high-reliability mode comprises driving the second actuator for ejecting the droplet of liquid by application of an ejection drive signal during a drive period; receiving the sense signal from the first actuator during a sensing period, the sensing period comprising the drive period; and analyzing the sense signal to determine whether the droplet of liquid has actually been ejected.

Thus, the first actuator senses the pressure variations during and after a drive actuation by the second actuator. Analyzing the pressure variations (i.e. a pressure wave) enables to verify that a droplet has actually been ejected, or not. If a droplet has not actually been ejected, an error signal may be generated, for example, and/or another droplet ejection unit may be actuated to compensate for the missing droplet.

In a particular embodiment, the control circuit comprises a first switch circuitry for switching a connection of the first actuator between a connection to the driving circuitry and a connection to the sensing circuitry; and a second switch circuitry for switching a connection of the second actuator between a connection to the driving circuitry and a connection to the sensing circuitry; and the method further comprises, after the drive period, switching a connection of the second actuator from a connection to the driving circuitry to a connection to the sensing circuitry; receiving a first sense signal from the first actuator and a second sense signal from the second actuator during the sensing period; analyzing the first and the second sense signals to determine whether the droplet of liquid has actually been ejected. After actuation, the second actuator may also be used as a sensor. Thus, a noise ratio may be reduced, for example, and a more reliable detection and analysis of a residual pressure wave may be achieved.

In an embodiment, the inkjet print head is operated in a high-speed quenching mode, wherein the high-speed high-viscosity mode comprises applying an ejection drive signal to at least one of the first and the second actuators for ejecting the droplet of the liquid in a drive period; applying a quench drive signal to the second actuator for suppressing a residual pressure wave in a quench period after the drive period; and after the drive period, receiving a quench sense signal from the first actuator during the quench period; and analyzing the quench sense signal.

In a particular embodiment, the quench drive signal may be adapted in response to the received quench sense signal. As known in the art, an actuator may be used after droplet ejection to damp a residual pressure wave in the liquid in order to prepare the acoustics for a subsequent droplet ejection. Still, such quenching operation is only effective if timed accurately with respect to the residual pressure wave. If timed incorrectly, the quenching actuation will amplify the residual pressure wave instead of damping it. Therefore, in this embodiment, the first actuator senses the residual pressure wave during the quenching operation. As soon as the residual pressure is sufficiently damped, a subsequent droplet ejection may be initiated. On the other hand, in the particular embodiment, if an amplitude of the residual pressure wave is not damped sufficiently or is even amplified, the quench drive signal may be adapted, preferably instantaneously, to achieve sufficient damping as soon as possible.

In an embodiment, the inkjet print head is operated in a high-speed low-viscosity mode, wherein the high-speed low-viscosity mode comprises applying an ejection drive signal to the second actuator for ejecting the droplet of the liquid in a drive period; receiving a residual pressure wave sense signal from the first actuator after the drive period; and analyzing the residual pressure wave sense signal. In this embodiment, a subsequent ejection drive signal is timed in response to the received residual pressure wave sense signal. With a low-viscosity liquid to be ejected, a single actuator, i.e. the second actuator, suffices for droplet ejection. Consequently, the first actuator may be used as a sensor. Moreover, for high-speed operation, a next droplet ejection may be timed based on the received sense signal such that the subsequent droplet ejection is stable and not negatively affected by the residual pressure wave. Apart from the timing, the drive signal may be adapted additionally or alternatively. For example, with a high amplitude of the residual pressure wave, a smaller drive signal amplitude may suffice for ejecting a droplet.

In another aspect the present invention provides an inkjet print head configured to perform the steps of the present invention. More specifically, the present invention provides an inkjet print head assembly comprising:

an inkjet print head comprising:
a droplet ejection unit comprising
   a pressure chamber;
   a first actuator configured for changing a volume of the pressure chamber;
   a second actuator configured for changing the volume of the pressure chamber; and
   a nozzle orifice;
a control circuitry operatively connected to the first actuator and the second actuator, the control circuitry comprising
   a drive circuitry for supplying a drive signal to at least one of the first and the second actuator;
   a sensing circuitry for receiving a sense signal at least from the first actuator; and
   a switch circuitry for switching a connection of at least the first actuator between a connection to the driving circuitry and a connection to the sensing circuitry; and

a controller configured for selecting a drive mode for driving at least one of the first and the second actuator for ejecting the droplet of the liquid through the nozzle orifice and for selecting a sensing mode for receiving the sense signal from the first actuator for detecting a pressure in the pressure chamber on the basis of at least one print property of a group of print properties, the group of print properties comprising a liquid viscosity, a liquid density, a droplet size, a printing productivity and a printing quality.

The controller of the assembly according to the present invention may be e.g. a processor as part of a component of the print head. Alternatively, the controller of the printing system wherein the print head is (to be) placed may be applied to control the switching between modes. In a further aspect, the present invention provides a printing system comprising an inkjet print head assembly according to the present invention as well as an inkjet print head for use in the inkjet print head assembly according to the present invention.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematic drawings which are given by way of illustration only, and thus are not limitative of the present invention, and wherein:

FIG. 1A shows a cross-section of a droplet ejection unit of an inkjet print head according to the present invention;

FIG. 1B illustrates a first embodiment of a control circuitry of an inkjet print head according to the present invention;

FIG. 1C illustrates a second embodiment of a control circuitry of an inkjet print head according to the present invention;

FIG. 2A-2C illustrate a first embodiment of a method of operating an inkjet print head in accordance with the present invention;

FIG. 3A illustrates a second embodiment of a method of operating an inkjet print head in accordance with the present invention;

FIG. 3B illustrates a third embodiment of a method of operating an inkjet print head in accordance with the present invention; and

FIG. 4 illustrates a fourth embodiment of a method of operating an inkjet print head in accordance with the present invention.

### DESCRIPTION OF THE INVENTION

The present invention will now be described with reference to the accompanying drawings, wherein the same reference numerals have been used to identify the same or similar elements throughout the several views.

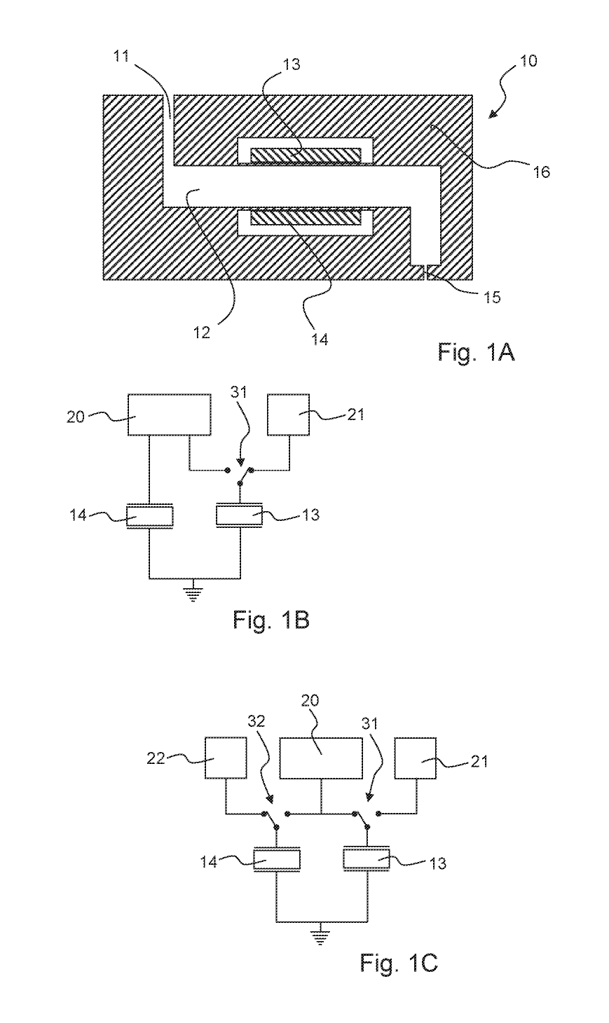

In FIG. 1A, an inkjet print head 10 is shown in cross-section to illustrate a droplet ejection unit comprising a liquid inlet port 11, a pressure chamber 12, a first actuator 13, a second actuator 14 and a nozzle 15. A print head body 16 may be made of silicon and the cavities and channels may have been formed by suitable processing, such as etching and lithographic techniques using silicon wafers. Still, the present invention is not limited to such embodiment and manufacturing. Any suitable materials and manufacturing methods are deemed to be within the scope of the present invention.

In more detail, a liquid may be received in the droplet ejection unit through the liquid inlet port 11. The liquid fills the pressure chamber 12 and the nozzle 15, where a meniscus is formed such that the liquid does not flow out of the nozzle 15. This is well known in the art and is not further elucidated herein.

When filled with liquid, at least one of the first and second actuators 13, 14 may be actuated. Upon actuation, the at least one actuator 13, 14 deforms, thereby changing a volume of the pressure chamber 12. The change in volume may be a decrease in volume to expel a droplet of liquid. Still, in most known methods, the volume is first increased, thereby sucking in more liquid through the liquid inlet port 11. Then, the volume is decreased again and a droplet of liquid is ejected through the nozzle 15. Since this kind of operation of an inkjet print head is well known in the art, it is not further elucidated herein.

The first actuator 13 and the second actuator 14 may be any kind of actuator that is suitable for changing the volume of the pressure chamber 12. A well-known kind of actuator for use in this type of inkjet print head is an electrostatic actuator or a piezo-electric actuator. In most known actual print heads, the piezo-electric actuator is employed. A known feature of at least the piezo-electric actuator is its suitability for use as a sensor. While applying an electric field over the piezo-electric material induces a mechanical change of a shape of the piezo-electric material, a mechanical change of the shape of the piezo-electric material similarly induces an electric field. Consequently, monitoring a voltage over electrodes of the piezo-electric actuator provides information on the shape of the piezo-electric material.

In inkjet print heads, it is known to use this principle to detect a pressure change in the liquid in the pressure chamber 12. In particular, it is known to have a piezo-electric actuator 13 being connected to a drive circuitry for expelling a droplet by application of a drive signal generated by the drive circuitry and thereby changing the volume of the pressure chamber 12 inducing a pressure wave in the liquid in the pressure chamber 12 such that the droplet is expelled. Then, after the drive signal is finished, the piezo-electric actuator 13 is quickly connected to a sensing circuitry by means of a switch circuitry, which sensing circuitry monitors the voltage over the electrodes of the piezo-electric actuator 13. The sensed voltage represents a residual pressure wave remaining in the liquid after ejection of the droplet. Analyzing this residual pressure wave provides detailed information on the acoustics in the pressure chamber 12. If any deviations in the acoustics are detected, it may be presumed that droplet formation and/or droplet ejection are disturbed.

In the inkjet print head 10 according to the present invention, two actuators 13, 14 are present per ejection unit, i.e. per pressure chamber 12. Such an arrangement is generally known for dual actuation or one actuator is only used for actuation and one actuator is used only for sensing. Thus, a relatively expensive print head is designed and such print head has limited commercial feasibility, since it is only commercially viable for applications requiring a very high reliability with respect to actual droplet ejection.

Referring to FIG. 1B, in a first embodiment, at least the first actuator 13 is arranged for either actuation or sensing. In particular, the second actuator 14 is connected between a common terminal and a drive circuitry 20, while the first actuator 13 is connected between the common terminal and a first switch circuitry 31. By means of the first switch circuitry 31, the first actuator 13 may be connected to the drive circuitry 20 or be connected to a first sensing circuitry 21. In a second embodiment, illustrated in FIG. 10, a second switching circuitry 32 may be added such that the second actuator 14 may be connected to the drive circuitry 20 or a second sensing circuitry 22.

Having a print head with at least two actuators 13, 14 of which at least one actuator 13 is capable of being used as an actuator and as a sensor enables many more applications and thus increases the commercial viability of such an inkjet print head 10 as is elucidated hereinbelow.

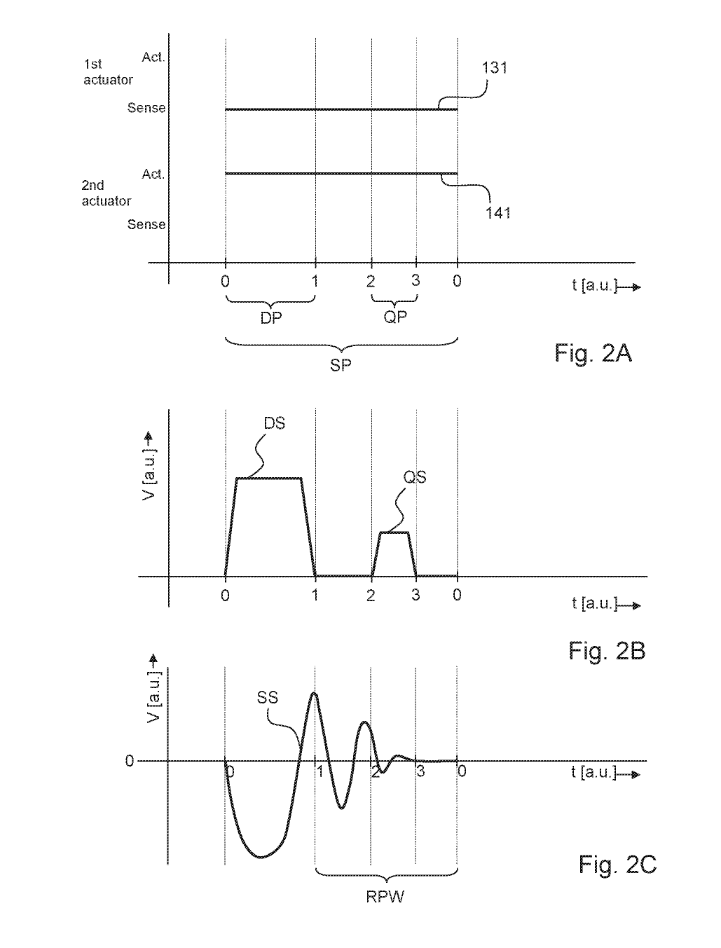

Now turning to FIG. 2A showing a timing diagram, wherein a horizontal axis represents time in arbitrary units [a.u.], for a first embodiment of a method according to the present invention, a first graph 131 shows a connection state of the first actuator 13. In particular, when the first graph 131 has a low value (‘Sense’), the first actuator 13 is connected to the first sensing circuitry 21. When the first graph 131 has a high value (‘Act.’), the first actuator 13 is connected to the driving circuitry 20. In FIG. 2A, the first graph 131 only has a low value ‘Sense’ and thus it is shown that the first actuator 13 is continuously connected to the first sensing circuitry 21.

Similarly, a second graph 141 shows a connection state of the second actuator 14. In particular, when the second graph 141 has a low value (‘Sense’), the second actuator 14 is connected to the second sensing circuitry 22. When the second graph 141 has a high value (‘Act.’), the second actuator 14 is connected to the driving circuitry 20. In FIG. 2A, the second graph 141 only has a high value ‘Act.’ and thus it is shown that the second actuator 14 is continuously connected to the driving circuitry 20. Consequently, the first embodiment of the method may be performed using either the first embodiment of the control circuitry of FIG. 1B or the second embodiment of the control circuitry of FIG. 1C.

In the timing diagram of FIG. 2A, it is assumed that a droplet ejection operation is started at t=0. The droplet ejection operation is divided in four stages: a first stage from t=0 to t=1, a second stage from t=1 to t=2, a third stage from t=2 to t=3 and a fourth stage from t=3 to t=0′. At t=0′, a subsequent droplet ejection operation may be initiated and started. Similar timing diagrams are shown in FIGS. 2B and 2C, wherein FIG. 2B illustrates a drive signal generated by the drive circuitry 20 and the timing diagram of FIG. 2C represents a sensing signal received by the first sensing circuitry 21. The same stages of the droplet ejection operation are indicated in these diagrams. In both diagrams, the vertical axis represents a voltage V in arbitrary units [a.u.].

As illustrated by FIGS. 2A-2C, during the first stage, a drive signal DS is generated in the drive circuitry 20 and this drive signal DS is supplied to the second actuator 14 in accordance with the second graph 141 of FIG. 2A. Thus, the first stage is also referred to as a drive period DP. During the drive period DP, a voltage of the drive signal DS first increases, stabilizes and then decreases. The voltage increase may induce a pressure chamber volume increase and the voltage decrease may induce a pressure chamber volume decrease, which may induce a droplet ejection as above described.

Referring to FIG. 2C showing a sensing signal SS received from the first actuator, indeed, a pressure in the liquid in the pressure chamber first decreases, thereby inducing a liquid supply flow through the liquid inlet port which eventually results in an increase of the pressure, which is further increased upon the decrease of the voltage of the drive signal DS at the end of the drive period DP. It is noted that in view of the continuous sensing operation of the first actuator as indicated in FIG. 2A by the first graph 131, in this embodiment, all four stages of the droplet ejection operation are included in a sensing period SP.

During the second stage, there is no voltage applied over the second actuator, which thus effectively is idle. The first actuator, in its sensing mode, registers a residual pressure wave RPW.

In a third stage of this embodiment, which may also be referred to as a quenching period QP, a quenching signal QS is supplied to the second actuator, which quenching signal QS is designed to quench or damp the residual pressure wave RPW to prepare the liquid and the droplet ejection unit for a next droplet ejection. As illustrated in FIG. 2C, the residual pressure wave RPW rapidly damps and reduces to zero.

It is noted that depending on, for example, the presence of an acoustics disturbing air bubble, the quenching pulse may result in attenuation of the residual pressure wave RPW. In such case and in a particular embodiment, the quench pulse QP may be instantaneously adapted in frequency, amplitude, timing, and the like aspects, in order to effectively achieve damping instead of attenuation.

After the fourth stage, at t=0′, a subsequent droplet ejection may be initiated without interference from the residual pressure wave RPW such that a stable droplet ejection is ensured. Thus, a synergetic effect of the presence of two actuators of which at least one is also available for sensing is achieved. Due to such synergetic effect, the additional costs may be commercially viable.

When designing a printing apparatus for a certain printing application, a skilled person may contemplate any application requirements. For example, if a functional image, such as an electrically conductive pattern, is to be printed, an application requirement may be that none of the dots to be printed is missed as such missed dot may lead to electrical shortage or a lack of conductivity, due to which the function of the image is lost and the image has become worthless. In another exemplary application, the costs for printing may be leading, requiring a print speed as high as possible, while some dots may be missed, since the omission of dots will be hardly visible. So, a skilled person may select certain settings and print modes to meet such application requirements. With the print head according to the present invention, a single printing apparatus may be equipped for multiple applications, wherein such applications may have completely different application requirements.

Herein, a term ‘drive mode’ is used to refer to a set of settings defining the method of ejecting droplets. For example, in view of the present invention, the drive mode defines whether one or multiple actuators are employed for generating a droplet. Further, the drive mode may include a setting relating to the use of a quench pulse, voltage amplitude of a drive pulse, timing of the drive pulse or drive pulses, and other aspects and settings apparent to those skilled in the art.

Similarly, as used herein, a term ‘sensing mode’ refers to a set of settings defining the method of sensing a pressure in a liquid in the pressure chamber over time. The sensing mode defines when at least the first actuator is switched to a sensing operation, i.e. to be connected through the switching circuitry to the sensing circuitry. Further, the sensing mode may define whether only the first actuator is used as a sensor or whether multiple actuators are used, at any time, as a sensor. The sensing mode may define any other aspects and settings related to the sensing operation of the inkjet print head according to the present invention as apparent to those skilled in the art.

Taking into account the application requirements, the driving mode and the sensing mode are selected on the basis of at least one print property of a group of print properties, the group of print properties comprising a liquid viscosity, a liquid density, a droplet size, a printing productivity and a printing quality. For example, a liquid with a low viscosity may be ejected with the use of a single actuator, while a liquid with a high viscosity is required to be ejected with at least two actuators. Achieving a larger droplet size may require actuation by at least two actuators, while a smaller droplet size is achievable with the use of a single actuator being actuated. A higher printing speed for high productivity may be achieved with combined actuation operation of both actuators, while a high quality (including high reliability) printing mode requires that at least one actuator is continuously operated as a sensor to accurately monitor the actual release of a droplet, when needed.

In an embodiment, for determining a suitable drive mode and/or a suitable sensing mode, acoustics of the inkjet print head filled with the liquid may be determined. In particular, a predetermined analysis drive signal may be applied to at least one of the first actuator and the second actuator and at least a sense signal may be received from the first actuator. Then, by analyzing the sense signal for determining at least one acoustic property of a group of properties of the pressure chamber and a liquid present in the pressure chamber, a suitable drive mode and a suitable sensing mode may be determined taking into account any application requirements. For example, the group of acoustic properties may comprise the liquid viscosity, the liquid density, an actuator efficiency and a presence of acoustic disturbances. While liquid viscosity and liquid density have a direct relation to the acoustics, the actuator efficiency relates to the operational and functional state of the actuator. For example, a piezo-electric material used in an actuator may become a smaller deformation in response to a certain actuation voltage over time. Therefore, to maintain ejection stability, droplet size, droplet speed and the like, an actuation voltage may need to be increased over the lifetime of the actuator. A sensed residual pressure wave may also be analyzed with respect to the presence of any acoustics disturbing objects or properties. For example, a gas bubble, usually an air bubble, may be entrapped in the pressure chamber. Such a bubble has a different compressibility (compliance) than the liquid resulting in a changed acoustic behavior in response to an actuator actuation and thus affecting droplet ejection. Such disturbances may be detected and suitable actions may be initiated to remove the disturbance or the ejection unit may be ignored during printing operation.

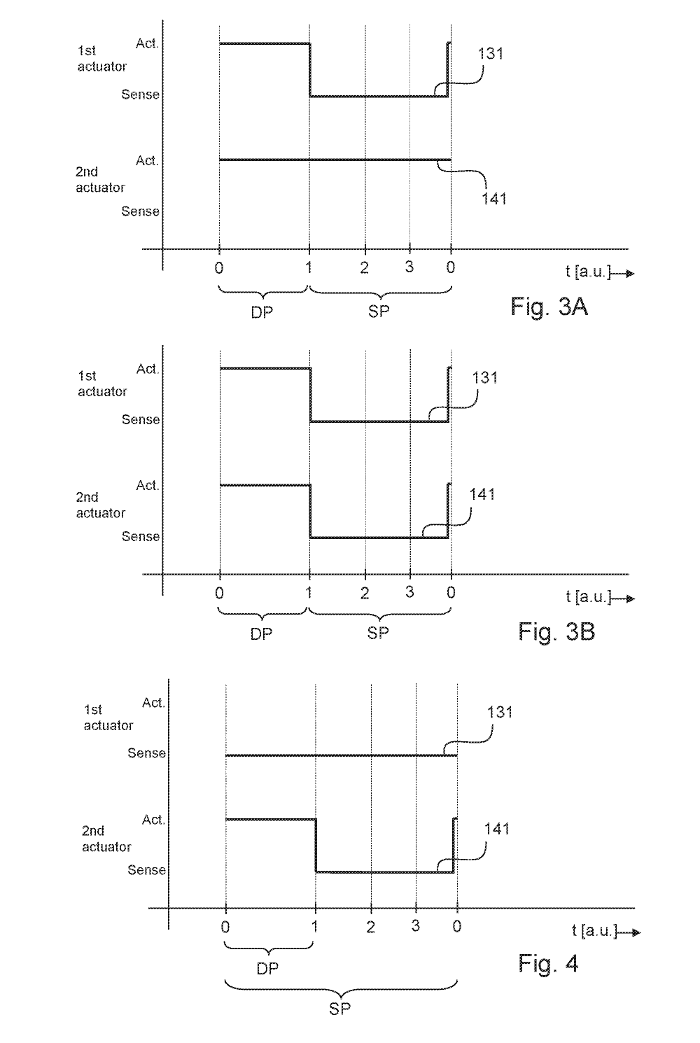

FIGS. 3A, 3B and 4 illustrate three embodiments of a drive mode and sensing mode for operating the inkjet print head according to the present invention. FIG. 3A illustrates a second embodiment, wherein the first actuator 13 is used as an actuator during a drive period DP and is used as a sensor in a sensing period SP after the drive period DP, as illustrated by the first graph 131. The second graph 141 shows that the second actuator 14 is used only as an actuator. For example, a quench pulse may be applied in the third stage (cf. FIG. 2B) or the actuator may be left idle or any other kind of operation may be performed with the second actuator 14 during the sensing period SP.

FIG. 3B illustrates a third embodiment, wherein the first actuator 13 is operated similar to the operation of the first actuator in the second embodiment of FIG. 3A. The second actuator 14 however is also used as sensor in the sensing period SP as apparent from the second graph 141. Thus, for example, noise reduction of the sensing signal SS may be achieved.

In a fourth embodiment illustrated in FIG. 4, a particular high reliability mode is illustrated. The first actuator 13 is continuously kept in a sensing operation, while the second actuator is used for ejection actuation and, directly after the drive period, is the switched to a sensing operation in the sensing period SP. Thus, the first actuator may sense the pressure in the liquid in the pressure chamber during droplet ejection, due to high amplitude already having a low noise contribution. The residual pressure wave may be sensed by both actuators for noise reduction, for example.

The different embodiments may be used independently and in combination. For example, an inkjet print head according to the present invention may be equipped with multiple ejection units. Then, the different ejection units may be operated in accordance with different drive modes and different sensing modes, depending on particular requirements of the application or reliability aspects. For example, if an ejection unit has not ejected a droplet for a longer period of time, it may be appropriate to use both actuators to expel a droplet, since the liquid may have dried at the nozzle and more power may be needed to expel the thickened liquid from the nozzle, while other ejection units may have been operated recently and would require less power for droplet ejection.

Likewise, when used for expelling droplets of different sizes, the drive mode may be selected per droplet, wherein only one actuator is used for expelling a small droplet and two actuators may be used for expelling a larger droplet. Thus, for example, the third embodiment of FIG. 3B may be used for expelling a larger droplet, while the fourth embodiment of FIG. 4 may be used for expelling a small droplet.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, it is contemplated that structural elements may be generated by application of three-dimensional (3D) printing techniques. Therefore, any reference to a structural element is intended to encompass any computer executable instructions that instruct a computer to generate such a structural element by three-dimensional printing techniques or similar computer controlled manufacturing techniques. Furthermore, such a reference to a structural element encompasses a computer readable medium carrying such computer executable instructions.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it is apparent that the same may be varied in many ways. Such variations are not to be regarded as a departure from the spirit and scope of the invention, and all such modifications as would be apparent to one skilled in the art are intended to be included within the scope of the following claims.

1. A method of operating an inkjet print head for ejecting a droplet of a liquid, wherein the inkjet print head comprises:
a droplet ejection unit comprising:
a pressure chamber;
a first actuator configured for changing a volume of the pressure chamber;
a second actuator configured for changing the volume of the pressure chamber; and
a nozzle orifice;
a control circuitry operatively connected to the first actuator and the second actuator, the control circuitry comprising:
a drive circuitry for supplying a drive signal to at least one of the first and the second actuator;
a sensing circuitry for receiving a sense signal from the first actuator; and
a switch circuitry for switching a connection of the first actuator between a connection to the drive circuitry and a connection to the sensing circuitry;
the method comprising:
selecting a drive mode for driving at least one of the first and the second actuator for ejecting the droplet of the liquid through the nozzle orifice; and
selecting a sensing mode for receiving the sense signal from the first actuator for detecting a pressure in the pressure chamber;
wherein the drive mode and the sensing mode are selected on a basis of at least one print property of a group of print properties, the group of print properties comprising a liquid viscosity, a liquid density, a droplet size, a printing productivity, and a printing quality.

2. The method according to claim 1, wherein the selecting the sensing mode follows after the selecting the drive mode.

3. The method according to claim 1, further comprising, prior to selecting the drive mode:
applying a predetermined analysis drive signal to at least one of the first actuator and the second actuator;
receiving the sense signal from the first actuator; and
analyzing the sense signal for determining at least one acoustic property of a group of properties of the pressure chamber and a liquid present in the pressure chamber, the group of acoustic properties comprising the liquid viscosity, the liquid density, an actuator efficiency, and a presence of acoustic disturbances.

4. The method according to claim 1, wherein the inkjet print head is operated in a high-productivity mode, the high-productivity mode comprising:
driving both the first and the second actuator in a predetermined interrelation for ejecting the droplet of the liquid.

5. The method according to claim 1, wherein the inkjet print head is operated in a high-reliability mode, the high-reliability mode comprising:
driving the second actuator for ejecting the droplet of liquid by application of an ejection drive signal during a drive period;
receiving the sense signal from the first actuator during a sensing period, the sensing period comprising the drive period; and
analyzing the sense signal to determine whether the droplet of liquid has actually been ejected.

6. The method according to claim 5, wherein the control circuitry further comprises:
a first switch circuitry for switching a connection of the first actuator between a connection to the drive circuitry and a connection to the sensing circuitry; and
a second switch circuitry for switching a connection of the second actuator between a connection to the drive circuitry and a connection to the sensing circuitry;
and wherein the method further comprises:
after the drive period, switching a connection of the second actuator from a connection to the drive circuitry to a connection to the sensing circuitry;
receiving a first sense signal from the first actuator and a second sense signal from the second actuator during the sensing period;
analyzing the first and the second sense signals to determine whether the droplet of liquid has actually been ejected.

7. The method according to claim 1, wherein the inkjet print head is operated in a high-speed quenching mode, the high-speed quenching mode comprising:
applying an ejection drive signal to at least one of the first and the second actuators for ejecting the droplet of the liquid in a drive period;
applying a quench drive signal to the second actuator for suppressing a residual pressure wave in a quench period after the drive period; and
after the drive period, receiving a quench sense signal from the first actuator during the quench period; and
analyzing the quench sense signal.

8. The method according to claim 7, wherein the quench drive signal is adapted in response to the received quench sense signal.

9. The method according to claim 1, wherein the inkjet print head is operated in a high-speed low-viscosity mode, the high-speed low-viscosity mode comprising
applying an ejection drive signal to the second actuator for ejecting the droplet of the liquid in a drive period; and
receiving a residual pressure wave sense signal from the first actuator after the drive period; and
analyzing the residual pressure wave sense signal,
wherein a subsequent ejection drive signal is timed in response to the received residual pressure wave sense signal.

10. An inkjet print head assembly comprising:
inkjet print head configured to eject a droplet of a liquid, the inkjet print head comprising:
a droplet ejection unit comprising:
a pressure chamber;
a first actuator configured for changing a volume of the pressure chamber;
a second actuator configured for changing the volume of the pressure chamber; and
a nozzle orifice;
a control circuitry operatively connected to the first actuator and the second actuator, the control circuitry comprising
a drive circuitry for supplying a drive signal to at least one of the first and the second actuator;
a sensing circuitry for receiving a sense signal at least from the first actuator; and
a switch circuitry for switching a connection of at least the first actuator between a connection to the driving circuitry and a connection to the sensing circuitry; and
a controller configured to: select a drive mode for driving at least one of the first and the second actuator for ejecting the droplet of the liquid through the nozzle orifice; and select a sensing mode for receiving the sense signal from the first actuator to detect a pressure in the pressure chamber on the basis of at least one print property of a group of print properties, the group of print properties comprising a liquid viscosity, a liquid density, a droplet size, a printing productivity, and a printing quality.

11. A printing system comprising the inkjet print head assembly according to claim 10.

12. The inkjet print head assembly according to claim 10, wherein the controller selects the sensing mode after the controller selects the drive mode.

13. The inkjet print head assembly according to claim 10, wherein the controller, prior to selecting the drive mode and the sensing mode, is further configured to cause the control circuitry to:
apply a predetermined analysis drive signal to at least one of the first actuator and the second actuator;
receive the sense signal from the first actuator; and
analyze the sense signal for determining at least one acoustic property of a group of properties of the pressure chamber and a liquid present in the pressure chamber, the group of acoustic properties comprising the liquid viscosity, the liquid density, an actuator efficiency, and a presence of acoustic disturbances.

14. The inkjet print head assembly according to claim 10, wherein the inkjet print head is operated in a high-productivity mode, the high-productivity mode comprising:
driving both the first and the second actuator in a predetermined interrelation for ejecting the droplet of the liquid.

15. The inkjet print head assembly according to claim 10, wherein the inkjet print head is operated in a high-reliability mode, the high-reliability mode comprising:
driving the second actuator for ejecting the droplet of liquid by application of an ejection drive signal during a drive period;
receiving the sense signal from the first actuator during a sensing period, the sensing period comprising the drive period; and
analyzing the sense signal to determine whether the droplet of liquid has actually been ejected.

16. The inkjet print head assembly according to claim 15, wherein the control circuitry further comprises:
a first switch circuitry for switching a connection of the first actuator between a connection to the drive circuitry and a connection to the sensing circuitry; and
a second switch circuitry for switching a connection of the second actuator between a connection to the drive circuitry and a connection to the sensing circuitry;
and wherein the controller is further configured to cause the control circuitry to:
after the drive period, switch a connection of the second actuator from a connection to the drive circuitry to a connection to the sensing circuitry;
receive a first sense signal from the first actuator and a second sense signal from the second actuator during the sensing period;
analyze the first and the second sense signals to determine whether the droplet of liquid has actually been ejected.

17. The inkjet print head assembly according to claim 10, wherein the inkjet print head is operated in a high-speed quenching mode, the high-speed quenching mode comprising:
applying an ejection drive signal to at least one of the first and the second actuators for ejecting the droplet of the liquid in a drive period;
applying a quench drive signal to the second actuator for suppressing a residual pressure wave in a quench period after the drive period; and
after the drive period, receiving a quench sense signal from the first actuator during the quench period; and
analyzing the quench sense signal.

18. The inkjet print head assembly according to claim 17, wherein the quench drive signal is adapted in response to the received quench sense signal.

19. The inkjet print head assembly according to claim 10, wherein the inkjet print head is operated in a high-speed low-viscosity mode, the high-speed low-viscosity mode comprising:
applying an ejection drive signal to the second actuator for ejecting the droplet of the liquid in a drive period; and
receiving a residual pressure wave sense signal from the first actuator after the drive period; and
analyzing the residual pressure wave sense signal; and
wherein a subsequent ejection drive signal is timed in response to the received residual pressure wave sense signal.
